(19) United States
(12) Patent Application Publication
(10) Pub. No.: US 2007/0260686 A1
(43) Pub. Date: Nov. 8, 2007

(54) Method and system for conferencing control

(75) Inventors: Kristoffer Charles Frydenlund, Portland, OR (US); Jeffery Alexander Dage, Vancouver, WA (US); Ian James Widger, Bellevue, WA (US)

Correspondence Address: ANDREW L. DISCHER, 148 PALMER STREET, NE, GRAND RAPIDS, MI, 49505, US

(73) Assignee: Encounter Collaborative Inc.

(21) Appl. No.: 11/418,916

(22) Filed: May 4, 2006

(51) Int. Cl. G06F 15/16

(52) U.S. Cl. 709/204

(57) ABSTRACT

A method for conferencing control includes determining at least one participant, determining at least one participant location corresponding to the participant, determining at least one participant indicator corresponding to the participant wherein the participant indicator is displayed on a representational interface based the participant location, determining a plurality of participant data for the participant, and associating the participant data with the participant indicator. A computer usable medium with suitable computer program code is employed for conferencing control.

### CROSS-REFERENCE TO RELATED APPLICATIONS

Not Applicable

### FEDERALLY SPONSORED RESEARCH

Not Applicable SEQUENCE LISTING OR PROGRAM LISTING

Not Applicable

### FIELD OF THE INVENTION

This invention relates generally to communications. In particular the invention relates to a method and system for conferencing control.

### BACKGROUND OF THE INVENTION

When managing conferences, including audio conferences, a control panel is used that provides information and control capabilities for

conferencing control. A list-based control panel shows a listing of conferences participants and information associated with each participant. This list allows the conference moderator to review information connected with the conference participants and control certain aspects of the conference, such as adding, dropping, and muting participants.

List-based audio conferencing control panels usually suffice for basic call control functions, but are inherently limited by the fact that the list can only convey as much information as a display screen can show at any one time. Additional information, that does not fit the display screen, must be hidden. In addition, status changes and information changes are not readily apparent when using a list-based control panel.

Reviewing information on a list-based control panel is serial in nature, since each line of the list is read or scanned, in sequence, to locate pertinent information. The meaning and relevance of that information is then determined before an appropriate action is determined. Furthermore, list-based interfaces are inherently deficient in conveying location specific information.

A list-based control panel can be enhanced with hypertext links to assist in viewing and managing data on a list. These enhanced list-based control panels quickly become cumbersome when managing a large number of conference participants. The value of information is limited when the context of that information cannot be determined. Without geographic relevance associated with the information much of the context is lost. Without effective participant management, the efficiency of the conference is limited. The conference moderator is constrained in the ability to react and respond to requests, responses, and other data received from participants.

It is therefore desirable to provide a method and system for classifying information that overcomes the limitations, challenges, and obstacles described above.

### SUMMARY OF THE INVENTION

One aspect of the invention provides a method for conferencing control. The method includes determining at least one participant, determining at least one participant location associated with the participant, determining at least one participant indicator corresponding to the participant wherein the participant indicator is displayed on a representational interface based the participant location, determining a plurality of participant data for the participant, and associating the participant data with the participant indicator.

Another aspect of the invention provides a computer readable medium storing a computer program including computer program code for conferencing control. The computer usable medium includes computer program code for determining at least one participant, computer program code for determining at least one participant location corresponding to the participant, computer program code for determining at least one participant indicator corresponding to the participant wherein the participant indicator is displayed on a representational interface based the participant location, computer program code for determining a plurality of participant data for the participant, and computer program code for associating the participant data with the participant indicator.

A third aspect of the invention provides a system for conferencing control. The system includes means for determining at least one participant, means for determining at least one participant location corresponding to the participant, means for determining at least one participant indicator corresponding to the participant wherein the participant indicator is displayed on a representational interface based the participant location, means for determining a plurality of participant data for the participant, and means for associating the participant data with the participant indicator.

The aforementioned and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates a flowchart representative of one example of a method for conferencing control, in accordance with the invention;

FIG. 2 illustrates a flowchart representative of one example of a method for determining participant data at block 140 of FIG. 1, in accordance with the invention;

FIG. 3 illustrates a flowchart representative of a second example of a method for determining participant data at block 140 of FIG. 1, in accordance with the invention;

FIG. 4 illustrates a flowchart representative of a third example of a method for determining participant data at block 140 of FIG. 1, in accordance with the invention;

FIG. 5 illustrates a flowchart representative of one example of a method for determining a participant indicator at block 125 of FIG. 1, in accordance with the invention;

FIG. 6 illustrates a flowchart representative of one example of a method for determining a participant location at block 120 of FIG. 1, in accordance with the invention;

FIG. 7 illustrates a schematic representative of one example of displaying participant indicators on a representational interface, in accordance with the invention;

FIG. 8 illustrates a schematic representative of one example of modifying the participant indicator based on the participant data, in accordance with the invention;

FIG. 9 illustrates a schematic representative of one example of displaying the participant data, in accordance with the invention;

FIG. 10 illustrates a schematic representative of one example of displaying participant feedback, in accordance with the invention; and

FIG. 11 illustrates a schematic representative of one example of a system for conferencing control, in accordance with the invention.

### DETAILED DESCRIPTION OF THE PRESENTLY PREFERRED EXAMPLES

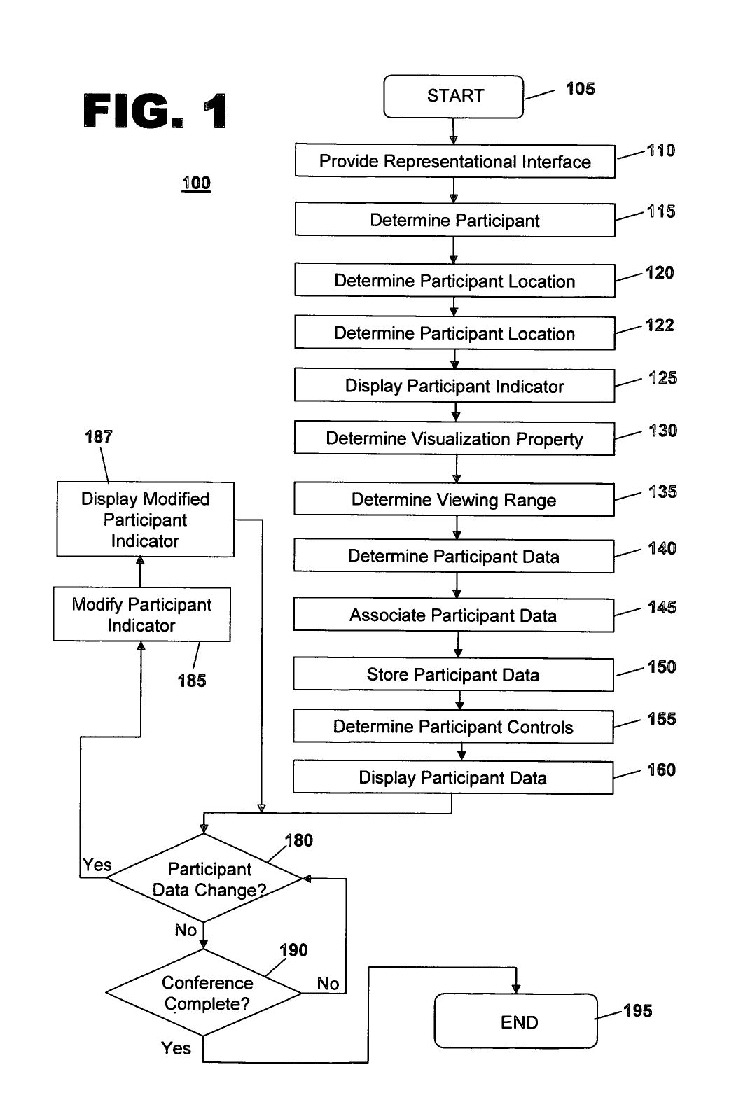

FIG. 1 illustrates a flowchart representative of one example of a method for conferencing control, in accordance with the invention at 100. The method begins at 105.

A conference is a meeting of more than one person or entity (participants) for consultation, deliberation, discussion, or interchange of opinions and information. A conference, such as an audio conference, consists of participants from different geographic locations and is conducted using communication equipment, such as phones or personal computers connected through a bridge. A representational interface, such as a map-based control panel, is provided for conferencing control (block 110). The map-based control panel is a conferencing control panel displaying controls and data useful for conferencing management. The controls and data are displayed on a map image within the map-based control panel.

In one embodiment the representational interface includes a picture in place of the map image. In other embodiments, the representational interface includes a designed graphic image, a line drawing, a scanned image or a collection of symbols in place of the map image.

The map-based control panel can include a static map, such as an image of the United States, or an interactive map having built-in placement and routing tools. Interactive maps include computer-based applications and internet-based mapping tools. Placement tools indicate a location based on a latitude/longitude record obtained from a database of locations.

A participant is determined for the conference (block 115). A conference involves at least one participant and a moderator. The moderator uses a control panel having a representational interface, such as a map-based control panel, to manage the conference. Moderators include presenters, educators, focus group leaders, workgroup supervisors and other participants with an interest in managing a conference. A participant requests access by placing a call using a landline phone, a wireless device or a voice over IP (VoIP) enabled device. The moderator determines the participant by granting or denying access to the conference by a participant candidate. The moderator uses pre-defined criteria to determine whether to grant access to the participant candidate. In one embodiment, a participant can act as the moderator. In another embodiment, more than one moderator manages the conference.

A participant location corresponding to the participant is determined (block 120). Geographical location information portrayed in the map-based control panel is obtained by looking up an automatic number identification (ANI) of the participant candidate in a database providing latitude/longitude data. In addition, customer-supplied addresses are referenced to the database. Other methods for obtaining location information include ascertaining geographical details associated with unique PINs or ANI's, using IP-address geo-coding methods, and discovering GPS coordinates. Databases supplying geographic location information include public and private databases.

A participant indicator is determined for the participant (block 122). The determined participant indicator is then displayed on the map-based control panel based on the participant location (block 125). The participant indicator is selected from a pre-defined group of available participant indicators. In one embodiment, the participant indicator is constructed using a tool for generating participant indicators. The participant indicator can take any form desired by the moderator or the participant. A default participant indicator is assigned where no preferences are indicated. In addition, a visualization property is determined (block 130) for the participant indicator. Visualization properties include color, visibility, flash/no-flash, and size. The visualization properties are each assigned a significance, such as informing the moderator that the participant is muted, wishes to ask a question, or has left the conference. In one embodiment, the visualization property is the same for all participant indicators.

A viewing range is determined for the map-based control panel (block 135). The viewing range establishes the field of view shown on the map-based control panel, such as a single building, a city, a state, an entire country, or multiple countries. In one embodiment the viewing range encompasses a geographic entity. In another embodiment the viewing range encompasses a graphical or pictorial representation of a single location or multiple locations where participants are located. Zooming controls are provided for interactively changing the viewing range as necessary.

In one embodiment, the participant indicator can represent a group of participants. If a visualization field is not large enough to display a separate participant indicator for each individual participant, a group indicator is displayed. For example, if multiple participants are located in the same building and the map-based interface illustrates an entire state, such as Oregon, the group indicator represents the multiple participants located in the same building. Group indicators are replaced by individual participant indicators as the map-based control panel is zoomed in and group indicators are generated and displayed as the map-based control panel is zoomed out.

Participant data is determined for the participant (block 140). Participant data is any information received from, assigned to, retrieved for, or otherwise associated with a participant. Participant data includes call status, participant indicator type, participant controls, participant feedback, demographic data, participant supplied location-specific information, SMS messages, converted speech, actions requested, actions completed, and call statistics. Other participant data, not listed, is included as needed. Participant information is prepared by and gathered from a number of sources such as the participant, the moderator, a moderator owned database, a public database, one or more configuration settings, and one or more third-party databases.

The participant data is associated with the participant indicator (block 145). The participant data is stored in a caller activity database for the duration of the conference (block 150). In one embodiment, participant data is retained in the caller activity database, after the conference is completed, for further processing and evaluation. Participant data that is associated with the participant indicator pertains to the participant or group of participants represented by the participant indicator.

Participant controls are determined for the participant indicator and are associated with the participant indicator (block 155). The moderator manages the conference through the map-based control panel using the participant controls such as, muting, un-muting, ejecting from the conference, blocking, promoting and demoting two-way listening mode, enabling instant message correspondence, viewing participant data, altering and clearing polling information, and setting up a side channel conversation. In one embodiment, the participant controls are predetermined. In another embodiment, the participant controls are selected by the moderator prior to the start of the conference. Participant controls are added and removed during the conference as needed.

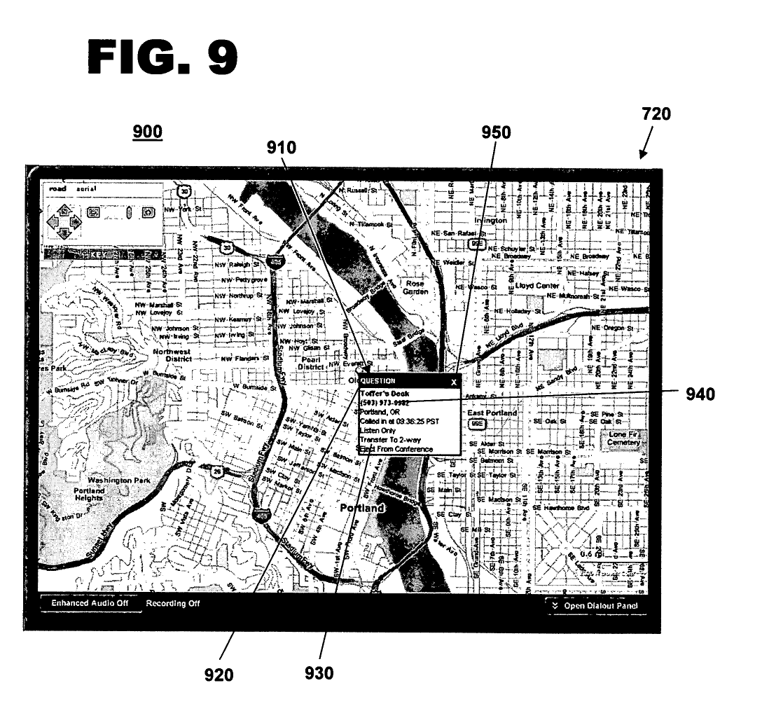

The participant data can be displayed responsive to a management event (block 160). Management events includes moving a mouse cursor over the participant indicator (mouse-over), combining the mouse-over with a mouse click, pressing a designated key on a keyboard, and a voice command. In one embodiment, a call-leg control box appears responsive to the management event. The call leg control box contains the participant data and participant controls as described below in FIG. 9. In one embodiment, the format of the participant data in the call-leg control box is configured by the moderator. In another embodiment, the format of the call-leg control box is configured by the moderator or a person designated by the moderator. The format includes order of the data, display font, display color, and size of the call-leg control box.

In one embodiment, if the participant data changes (block 180) the participant indicator is modified (block 185) based on the new participant data associated with the participant indicator and the modified participant indicator is displayed (block 187). For example, if a participant wishes to ask a question the associated participant indicator is modified from a person icon to a question mark icon. In another example, if a participant is muted the person icon associated with the participant is grayed out.

A determination is made whether the conference is complete (block 190). If the conference is not complete the method repeats the determination of whether there is a change in the participant data (block 180). If the conference is complete the method terminates (block 195).

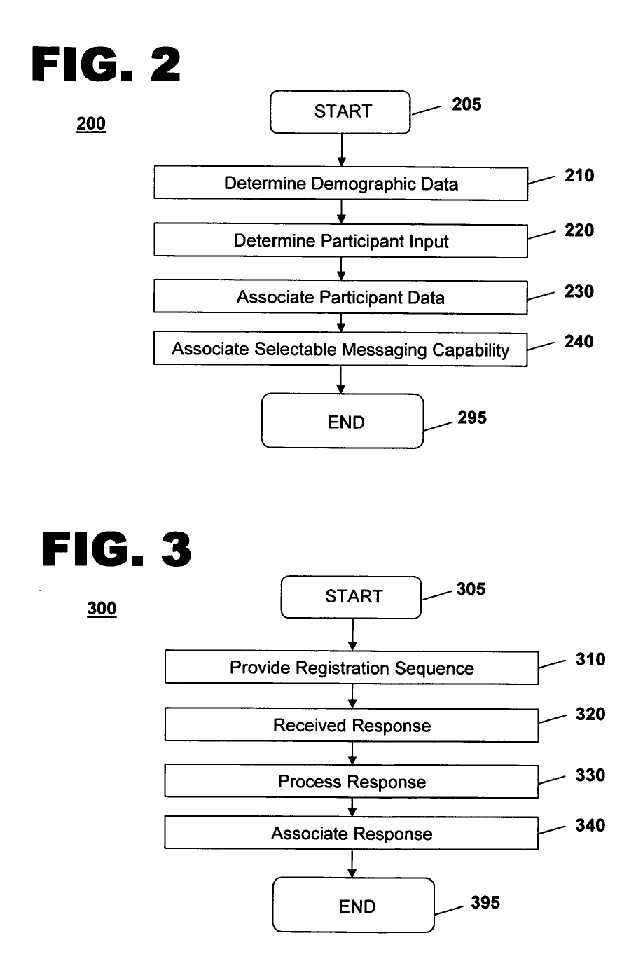

FIG. 2 illustrates a flowchart representative of one example of a method for determining participant data at block 140 of FIG. 1, in accordance with the invention at 200. The method begins at 205.

Additional participant data is associated with the participant indicator as necessary. The additional participant data included is dependent on the purpose for which the conference is conducted. Additional participant data is associated with the participant indicator at any time during the conference.

In one example, demographic data is included in the participant data. The demographic data is determined (block 210) by reference to a database of demographic information or other source of demographic information. Demographical details such as average income, nearby restaurants, proximity to airports and other demographic information relevant to the participant location is included. Demographic data is available from several sources including a moderator database, a third-party database, a participant database, and a public database. Demographic data is unique to each participant and is related to the geographic location of the participant. In one embodiment, demographic data is directly supplied by the moderator, the participant, or a third-party.

In another example, participant input is included in the participant data. The participant input is determined (block 220). Participant input includes participant generated text, converted audio, pictures, video, hypertext link, or feedback. The participant input can include a link directed to a location where the participant input resides. The participant input is determined by requesting and receiving the participant input and evaluating its relevance to the conference.

The demographic data and the participant input are participant data that is associated with the corresponding participant indicator (block 230).

In an additional example, a selectable messaging capability is provided in the participant data. The selectable messaging capability, such as SMS messaging, or speech recognition is associated with the participant indicator (block 240) and allows the moderator or an authorized participant to view a text message initiated by the participant.

In an exemplary embodiment, a TV or radio station can use a map-based control panel to get a better understanding of who is calling a show, where they are calling from and how long they have been holding. This information is included in the participant data. With the addition of SMS messaging or speech recognition with the participant data, the host of a TV or radio show can view text of an audience member question along with information, such as call wait time and call hold time prior to interacting with the participant.

In another exemplary embodiment, a TV or radio show solicits viewers to place a vote by phone for a favorite artist. The vote received is indicated by a participant indicator on a map-based control panel. Participant data that indicates a voting result and where the vote was made geographically is associated with the participant indicator. Votes placed via email or via a web-enabled interface can also be redirected to the map-based control panel and depicted by a participant indicator. One or more visualization properties are assigned to the participant indicator as needed to signify the voting result, the vote origin, or some combination of significances.

The method terminates at block 295.

FIG. 3 illustrates a flowchart representative of a second example of a method for determining participant data at block 140 of FIG. 1, in accordance with the invention at 300. The method begins at 305.

The participant is provided a registration sequence (block 310). The registration sequence is a series of questions requesting information from the participant. Response to the registration sequence is received at and reviewed through the representational interface (block 320). Responses include a verbal response, a text message, an email message, a message input through a web-enabled interface, and a speech to text converted response.

The response to the registration sequence is processed (block 330). In one embodiment, the registration sequence is used to collect relevant participant information to be included as participant data. The relevant participant data includes name, account number, passcode for the conference, and group associations. In another embodiment, the registration sequence validates a participant identity and controls access to the conference. In another embodiment, a business receiving calls, such as a radio station, can solicit caller information and questions from the caller prior to connecting the call.

The response is associated with the participant indicator (block 340). The response can be viewed using the appropriate management event. In one embodiment, the response triggers a change in the participant indicator.

The method terminates at block 395.

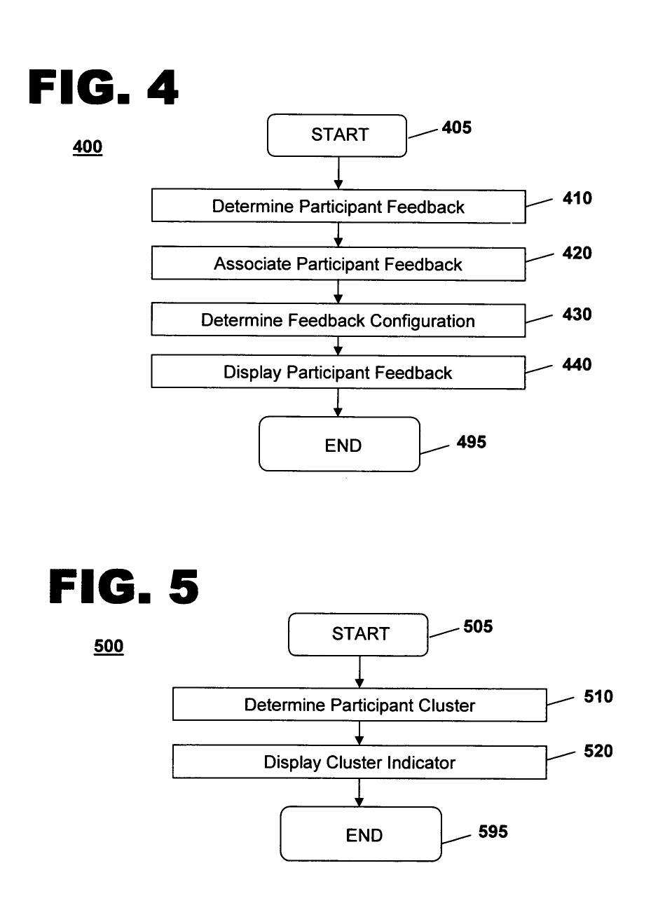

FIG. 4 illustrates a flowchart representative of a third example of a method for determining participant data at block 140 of FIG. 1, in accordance with the invention at 400. The method begins at 405.

Where a moderator is interested in feedback from a single participant or a group of participants, the map-based control panel provides a geographic relevance to the feedback. Participant data, such as, participant feedback is determined (block 410) by polling the participants or some subset of participants and receiving the results at the map-based control panel. In one embodiment, the participants are provided with polling questions prior to the conference. The participant feedback is received at a designated time prior to or during the conference.

The participant feedback is associated with the individual participant indicators (block 420). A feedback configuration is determined (block 430) that allows the moderator or other user of the map-based control panel to pre-determine how, when, and where the participant feedback is displayed. In one embodiment, a default feedback configuration is used. In another embodiment, no feedback configuration is used.

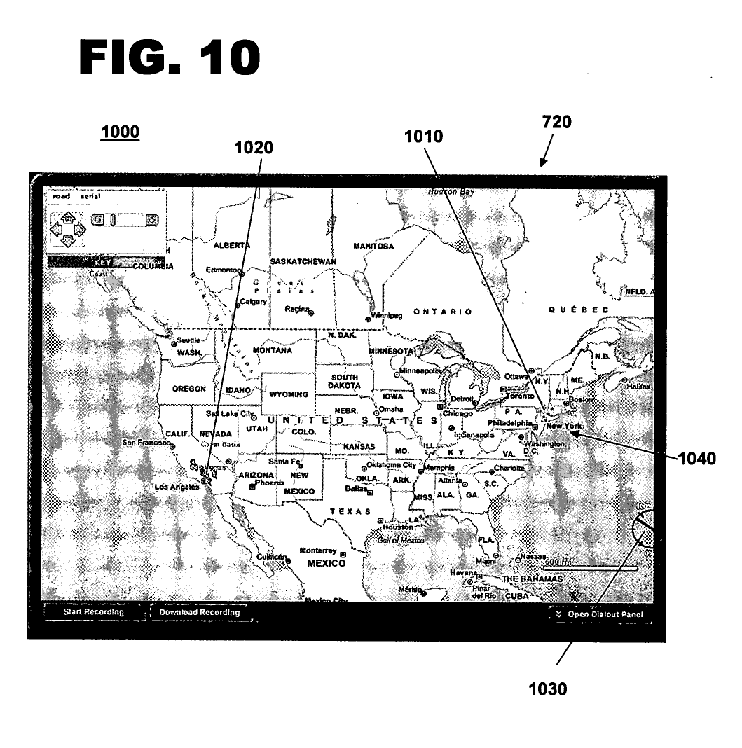

The participant feedback is associated with the respective participant indicator and displayed on the map-based control panel (block 440) based on the feedback configuration. The participant feedback is displayed in response to a management event. In one embodiment the feedback is represented by a change in the participant indicator, such as a color change or a shape change. In another embodiment the feedback is displayed directly on the map-based control panel. An example of feedback displayed on a map-based control panel is shown below in FIG. 10.

The method terminates at block 395.

FIG. 5 illustrates a flowchart representative of one example of a method for determining a participant indicator at block 125 of FIG. 1, in accordance with the invention at 500. The method begins at 505.

A participant cluster is determined based on a common participant factor (block 510). The common participant factor shows a connection that is unique to a group or a subset of participants. Common participant factors include participants in the same building, the same business, the same city, the same age range, the same gender, or the same organization association. In one embodiment, participants providing the same answer to a specific question in the registration sequence described in FIG. 3 are included in a participant cluster. In another embodiment, participants providing the same participant feedback as described in FIG. 4 are included in a participant cluster. Common participant factors are useful if the moderator wants to segment the participants in some manner, for purposes of segregating feedback, or assembling conference data.

A cluster indicator is displayed based on the determined participant cluster (block 520). The cluster indicator is a participant indicator that encompasses all the participants in the participant cluster. In one embodiment, the cluster indicator is a single indicator displayed on the map-based control. In another embodiment, the cluster indicator is an identical indicator associated with each participant in the participant cluster. For example, if the participant cluster includes all participants located in Oregon, the Oregon state flag is assigned as the participant indicator for those participants in the cluster. In another example, if the participant cluster is all participants that are female then the participant indicator for all female participants is red. Any combination of common participant factors and participant indicators is available according to the preference of the moderator or other conference manager.

The cluster indicator is selected from a pre-defined group of available cluster indicators. In one embodiment, the cluster indicator is constructed using a tool for generating cluster indicators. The cluster indicator can take any form desired by the moderator or the participants. A default cluster indicator is assigned where no preferences are indicated. Cluster indicator has visualization properties as discussed in FIG. 1 above.

The method terminates at block 595.

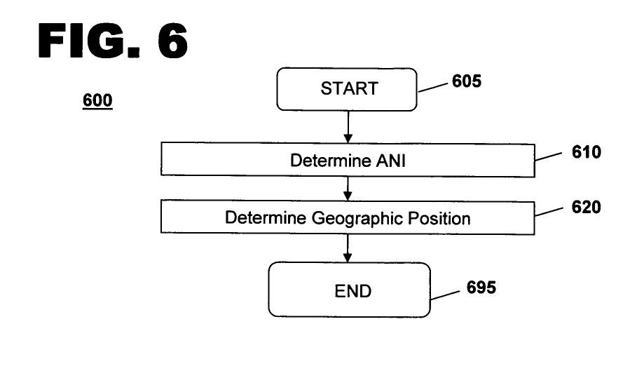

FIG. 6 illustrates a flowchart representative of one example of a method for determining a participant location at block 120 of FIG. 1, in accordance with the invention at 600. The method begins at 605.

An automatic number identification (ANI) is determined (block 610). The ANI is determined from the call received from the participant. The ANI identifies what location a caller is calling from based on the phone number assigned to the phone or device used by the participant during the conference.

A geographic position is determined based on the automatic number identification (block 620). The geographic position is available in a database containing phone numbers along with a location the phone number is assigned to. The database can include mobile phone information with links to a database containing location data for the mobile phone at a particular point in time. Databases with information for mobile phones are available from a wireless network provider supplying services to mobile phones. Databases of ANI locations are available from public and private sources. A moderator database is used to store location information for participants frequently attending a conference managed by the moderator. Number portability can effect the ability to determine a geographic position based on an ANI.

The method terminates at block 695.

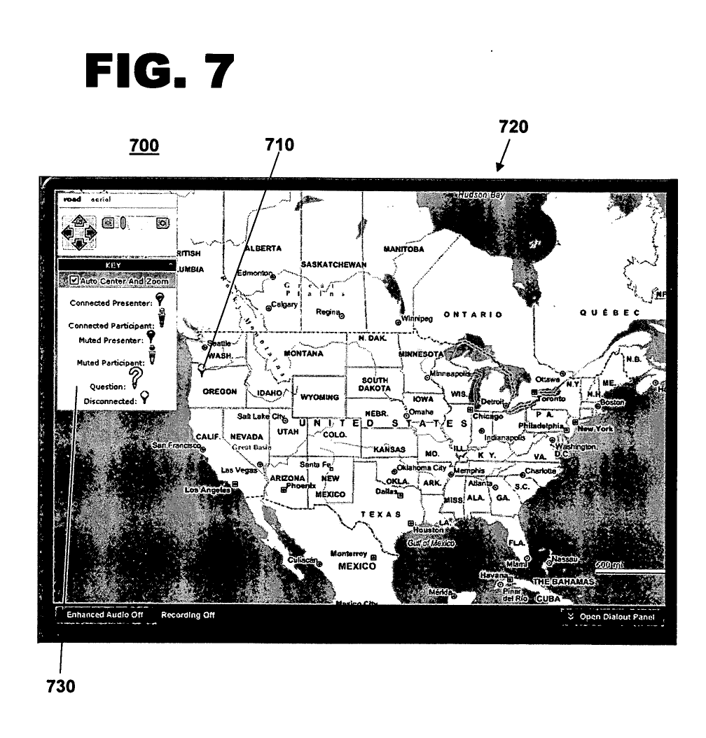

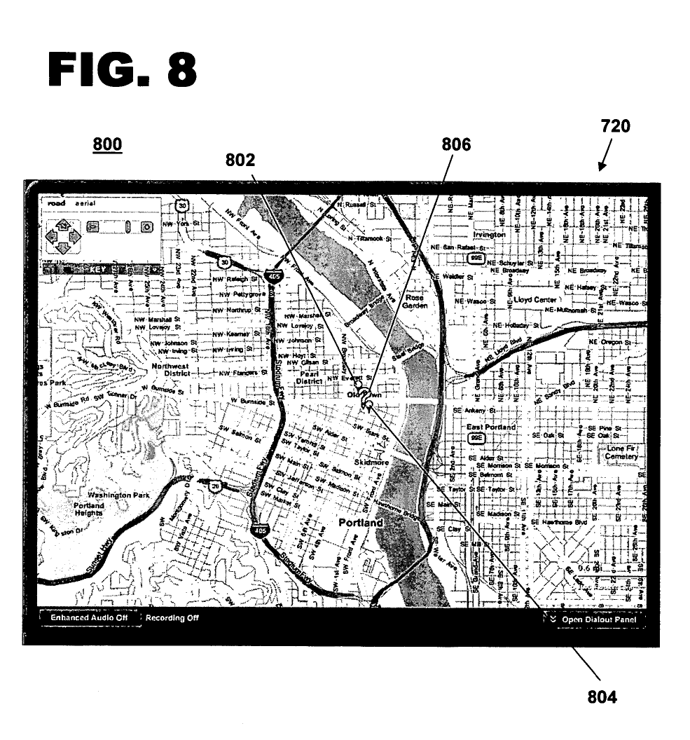

FIG. 7 illustrates a schematic representative of one example of displaying participant indicators on a representational interface, in accordance with the invention at 700.

Participant data such as call status is signified by the participant indicator 710. A representational interface 720, shown here as a map-based control panel showing North America, includes the participant indicator 710 selected from a group of available participant indicator types. In the example shown, a pin icon having an open head is selected. A key 730, indicates the meaning of the available participant indicator types. In this example, the participant indicator shown indicates a disconnected participant.

FIG. 8 illustrates a schematic representative of one example of modifying the participant indicator based on the participant data, in accordance with the invention at 800.

The representational interface 720, is shown here as a map-based control panel showing the city of Portland, Oreg., and includes three participant indicators 802, 804, and 806. Participant indicators 802 and 804 are shown as a pin icon. Participant indicator 806 was modified because the participant has a question for the moderator and is now displayed as a question mark.

FIG. 9 illustrates a schematic representative of one example of displaying the participant data, in accordance with the invention at 900.

The representational interface 720, is shown here as a map-based control panel showing the city of Portland, Oreg. and includes a call-leg control box 910. Participant data that is associated with a participant indicator is displayed in call-leg control box 910. The call-leg control box includes participant data such as call status information 920, call control selections 930, participant indicator type 940, and a hide button 950. Other data is displayed based on a call-leg control box configuration.

FIG. 10 illustrates a schematic representative of one example of displaying participant feedback, in accordance with the invention at 1000.

The representational interface 720, is shown here as a map-based control panel showing a map of North America and includes participant indicators 1010 and 1020. Positive responses are represented by bolded participant indicators 1010 and negative responses are represented by grayed participant indicators 1020. An overall response status is shown by an indicator 1030 that shows the percentage of positive or negative responses in a visual graphic form. The map-based control panel 720 allows the moderator to see that most of the negative responses were from participants in a particular location, shown here as the northeast portion of the USA 1040.

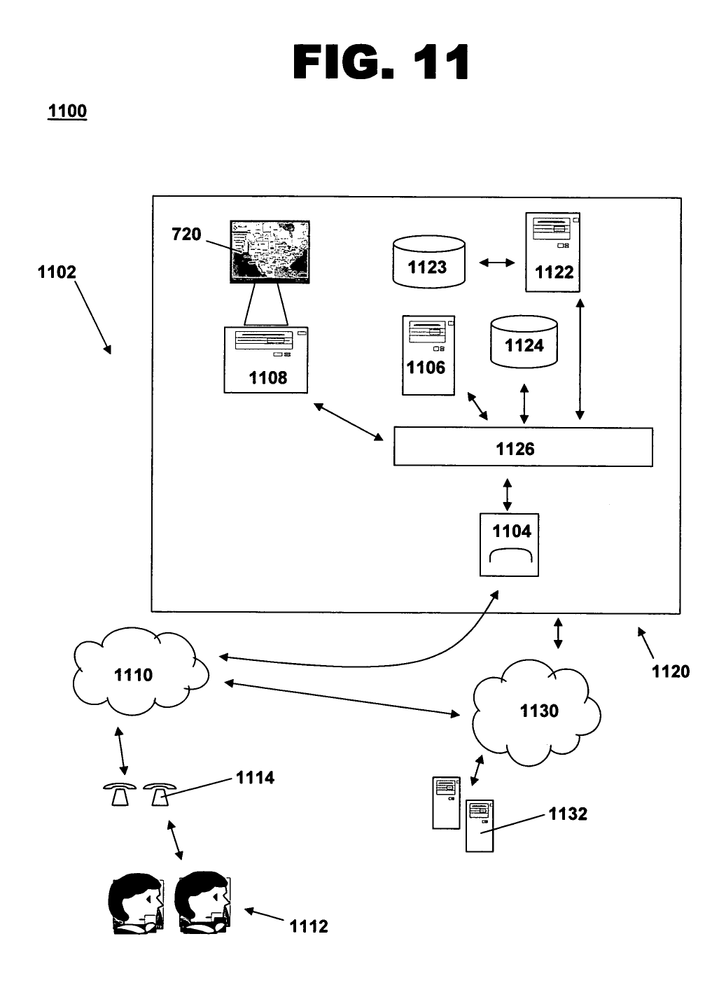

FIG. 11 illustrates a schematic representative of one example of a system for conferencing control, in accordance with the invention at 1100.

Conferencing control system 1102 includes a conferencing bridge 1104, an update server 1106, a control system 1108, and one or more communication networks 1110 providing services for one or more participants 1112.

Communication network 1110 connects participants 1112 to conferencing bridge 1104. In one example, communication network 1110 is a public-switched telephone network (PSTN). In another example, communication network 1110 is implemented as an Internet protocol (IP) network. In other examples, communication network 1110 is implemented as a wired network, an optical network, a fiber network, a wireless network, or any combination thereof. Communication network 1110 is connected to one or more communication devices 1114, such as landline telephones, voice over IP (VoIP) telephones, and other VoIP enabled communication devices.

Conferencing bridge 1104 connects, participants 1112 to update server 1106 and control system 1108 at a moderator center 1120. Conferencing bridge 1104 sends relevant call and conference information to update server 1106 through a service network 1126. Moderator center 1120 is a location where conferencing control system 1102 is managed. In one example, moderator center 1120 is a location operated by the party initiating the conference. In another example, moderator center 1120 is a third party service provider, providing conference management services.

Update server 1106 is any suitable hardware and software capable of providing updates to control system 1108. Update server is connected to conferencing bridge 1104, control system 1108, a location server 1122, and a caller activity database 1124 through service network 1126. Update server queries location server 1122 for location and demographic information and sends the information to control system 1108. Update server 1106 stores call activity, caller information, location information, demographic information, and other selected data in call activity database 1124.

Location server 1122 is connected to location database 1123. Location server is any suitable hardware for determining and storing geographic and demographic information. Location server includes GPS hardware (not shown) and is located at moderator center 1120. In one embodiment the location server is a commercial database or other third party database capable of providing relevant information and is located at a third-party location (not shown).

Control system 1108 is any suitable hardware for displaying a control panel having a representational interface 720 and for receiving management input to control panel 720. In one embodiment, control system 1104 and update server 1106 are combined. Control system 1108 receives updates and determines the appropriate class and status of the update. Control system 1108 generates system chosen or user chosen participant indicators and displays them on control panel 720.

In one example, control system 1108 includes a computer usable medium to execute Internet browser and Internet-access computer programs for sending and receiving data over network 1110 and, optionally, any number of additional wired or wireless communication networks 1130. Additional communication networks 1130 include external or remote networks and include any number of remote systems 1132. Additional communication network 1130 is connected to network 1110 and, optionally, moderator center 1120.

While the examples of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method for conferencing control comprising:
determining at least one participant;
determining at least one participant location corresponding to the participant;
determining at least one participant indicator corresponding to the participant wherein the participant indicator is displayed on a representational interface based the participant location;
determining a plurality of participant data for the participant; and
associating the participant data with the participant indicator.

2. The method of claim 1 further comprising:
determining a viewing range based on the participant indicator and the representational interface.

3. The method of claim 1 further comprising:
determining at least one visualization property for the participant indicator.

4. The method of claim 1 further comprising:
determining a plurality of participant controls associated with the participant indicator.

5. The method of claim 1 further comprising:
storing a plurality of conference data in a caller activity database.

6. The method of claim 1 further comprising:
displaying the participant data responsive to a management event.

7. The method of claim 1 further comprising:
modifying the participant indicator based on the participant data.

8. The method of claim 1 further comprising:
determining demographic data wherein the demographic data is associated with the participant indicator.

9. The method of claim 1 further comprising:
determining participant input wherein the participant input is associated with the participant indicator.

10. The method of claim 1 further comprising:
associating selectable messaging capability with the participant indicator.

11. The method of claim 1 wherein determining a plurality of participant data comprises:
providing a registration sequence;
receiving a response to the registration sequence at a conference manager;
verifying the response to the registration sequence associating the response with the participant indicator.

12. The method of claim 1 wherein determining a plurality of participant data comprises:
determining a plurality of participant feedback;
associating the participant feedback with the participant indicator;
determining a feedback configuration; and
displaying the participant feedback on the representational interface based on the feedback configuration.

13. The method of claim 1 wherein determining a participant indicator comprises:
determining a participant cluster based on a common participant factor;
displaying a cluster indicator based on the determined participant cluster.

14. The method of claim 1 wherein determining the participant location comprises:
determining an automatic number identification; and
determining a geographic position based on the automatic number identification.

15. A computer usable medium storing a computer program including computer program code for conferencing control, the computer usable medium comprising:
computer program code for determining at least one participant;
computer program code for determining at least one participant location corresponding to the participant;
computer program code for determining at least one participant indicator corresponding to the participant wherein the participant indicator is displayed on a representational interface based the participant location;
computer program code for determining a plurality of participant data for the participant; and
computer program code for associating the participant data with the participant indicator.

16. The computer usable medium of claim 15 further comprising:
computer program code for determining a viewing range based on the participant indicator and the representational interface.

17. The computer usable medium of claim 15 further comprising:
computer program code for determining at least one visualization property for the participant indicator.

18. The computer usable medium of claim 15 further comprising:
computer program code for determining a plurality of participant controls associated with the participant indicator.

19. The computer usable medium of claim 15 wherein computer program code for determining a plurality of participant data comprises:
computer program code for determining a plurality of participant feedback;
computer program code for associating the participant feedback with the participant indicator;
computer program code for determining a feedback configuration; and
computer program code for displaying the participant feedback on the representational interface based on the feedback configuration.

20. A system for conferencing control comprising:
means for determining at least one participant;
means for determining at least one participant location corresponding to the participant;
means for determining at least one participant indicator corresponding to the participant wherein the participant indicator is displayed on a representational interface based the participant location;
means for determining a plurality of participant data for the participant; and
means for associating the participant data with the participant indicator.
